(19) United States
(12) Patent Application Publication
(10) Pub. No.: US 2007/0234607 A1
(43) Pub. Date: Oct. 11, 2007

(54) Continuously displaying frame for animation

(75) Inventor: Tony Chuang, Taipei Hsien (TW)

Correspondence Address: BRUCE H. TROXELL, SUITE 1404, 5205 LEESBURG PIKE, FALLS CHURCH, VA, 22041, US

(73) Assignee: Trusty Industrial Inc.

(21) Appl. No.: 11/375,353

(22) Filed: Mar. 15, 2006

(51) Int. Cl. G09F 19/14

(52) U.S. Cl. 40/453

(57) ABSTRACT

An animation continuously displaying frame comprising at least a framework, a picture sheet, a grating plate as well as a combination member composed of a round rotating member with an eccentric hole and a movably mounted motor; the picture sheet and the grating plate are assembled in the framework to change positions or angular positions of the picture sheet or the grating plate by means of the round rotating member eccentrically mounted on a rotating axle of the motor and driven by the motor, thereby an effect of automatically changing the pictures on the grating plate can be obtained.

### BACKGROUND OF THE INVENTION

1. Field of the invention

The present invention is related to an animation continuously displaying frame which can be a picture frame or an advertisement billboard, and especially to a displaying frame having effects that at least two pictures automatically adjusted and changed according to the nature of the pictures to present different displaying effects.

2. Description of the Prior Art

Products each with the effect of changing of two or more than two pictures manufactured according to the principle of refraction of a cylindrical mirror grating or manufactured by the principle of visual line illusion of a printed grating film are more and more popularized; each product with multiple changing pictures originally has a grating plate clung on a picture sheet, and then a viewer moves to a different angular viewing position, the changing of the multiple pictures can thus be seen.

In order to meet the requirement of advertisement to elevate the visual effect and to attract people's eye sights, there have been various automatically picture changing frames developed. Although the mechanisms of them are more or less different, they all observe a principle, that is, in each case, the grating plate is separated from a picture sheet, a motor is provided to drive either of the grating plate and picture sheet, so that a viewer stay at a position unmoved can see nonstop changing of the pictures.

The structure has a defect: That is, a motor is rotated with a fixed rotational speed, when an eccentrically rotating round member with an axle as a rotating center drives the different pictures to make changing, by virtue that the motor does not have a movable position adjusting device, it can not make sure of the correct initial position of a first picture, the pictures having the first action to the last action desired to get an effect of continuous motion are unable to perfectly present this effect.

FIGS. 1A to 1B show the basic principle for seeing changing of pictures from a grating plate: in FIG. 1A, when a sight 503 of two eyes enters the grating plate 2, the focusing scope is reduced by virtue of refraction of light beams, a fixed focusing area 504 exists on the bottom of the grating plate 2; when two pictures are arranged in a picture sheet 3 to tightly cling on the bottom of the grating plate 2 in a mode of alternately placing for odd number and even number pictures (shown with A and B), if a picture B under the fixed focusing area 504 is exactly a complete image area, the picture B seen on the grating plate 2 is complete; if a picture A under the fixed focusing area 504 is exactly a complete image area, the picture A seen on the grating plate 2 is also complete (as shown in FIG. 1B), if the area under the fixed focusing area 504 includes parts of both pictures A and B (as shown in FIG. 1C), what is seen on the grating plate 2 is a cross changing phenomenon of the two pictures A and B.

Referring to FIG. 1D, a picture sheet 3 is composed of five pictures of a series of continuous actions, the picture sheet 3 is fixed on a plain plate 301, a round rotating member 106 is connected with the plain plate 301, the round rotating member 106 is eccentrically mounted on a rotating axle 204 of a fixed motor 105; if the third picture on the picture sheet 3 is exactly in the focusing scope of the grating plate 2, by virtue that a conventional picture changing frame does not have a movable position adjusting device on a motor, the pictures on the grating plate 2 will be repeatedly presented in the sequence of 3,4,5,1,2 and 2,1,5,4,3, wherein the picture of the first action is unable to be located at the initial position.

### SUMMARY OF THE INVENTION

The motor for the animation continuously displaying frame of the present invention is installed in the mode of movably adjusting position, the micro-adjusting motor can locate the picture of the first action at the initial position, and the pictures on the grating plate are repeatedly presented in the sequence of 1,2,3,4,5 and 5,4,3,2,1 as compared with the conventional picture changing frame.

The round rotating member of the animation continuously displaying frame of the present invention is a right round member, a non-circular hole is provided at the right side of the center of the round member and matches with a protruding rotating axle of a motor. The round rotating member with the eccentric center of the rotating axle of the motor is placed in an opening of a moving article, the moving article is connected with the grating plate or the picture sheet for changing angle or position.

When the rotating axle is rotated, the moving article being moved always follows the rotating of the rotating axle to move step by step, that makes the grating plate or the picture sheet gradually change its angle for presentation, this gets the object that the pictures in the picture sheet present their dynamic changing.

The key point of the improvement of the present invention is resided in that, the motor is provided thereon with a device for adjusting the position or height of the motor in order to adjust the first picture on the grating plate to get its initial position for completely presenting.

The present invention will be apparent after reading the detailed description of the preferred embodiments thereof in reference to the accompanying drawings.

### BRIEF DESCRIPTION OF THE DRAWINGS

FIGS. 1A to 1D are schematic views showing different situations resulting from the positions of a grating plate and a picture sheet of a conventional display frame;

FIG. 1E is a schematic view showing the situation resulting from the positions of a grating plate and a picture sheet of the present invention;

FIGS. 2A to 2E are schematic views showing the moving actions of a round rotating member eccentrically mounted on a rotating axle of an animation continuously displaying frame of the present invention;

FIG. 3 is a front view of an advertisement billboard of the animation continuously displaying frame of the present invention;

FIG. 4 is a sectional side view of the advertisement billboard of the animation continuously displaying frame the present invention;

FIG. 5A is a perspective view showing a back plate, a picture sheet and a grating plate of the animation continuously displaying frame of the present invention to be assembled;

FIG. 5B is a front view showing the back plate, the picture sheet and the grating plate of the animation continuously displaying frame of the present invention after assembling;

FIGS. 6 and 7 are schematic views showing the operation of using a round rotating member to change the angles of a picture sheet and a grating plate of the animation continuously displaying frame of the present invention;

FIG. 8 is a schematic view showing another embodiment of the advertisement billboard of the animation continuously displaying frame of the present invention;

FIGS. 9A to 9C are schematic views showing respectively a smaller and a larger round rotating member of the animation continuously displaying frame of the present invention;

FIG. 10 is a schematic perspective view showing assembling of a combinative round rotating member of the animation continuously displaying frame of the present invention;

FIG. 11 is a schematic front view of an integral round rotating member of the animation continuously displaying frame of the present invention.

### DETAILED DESCRIPTION OF THE PREFERRED EMBODIMENT

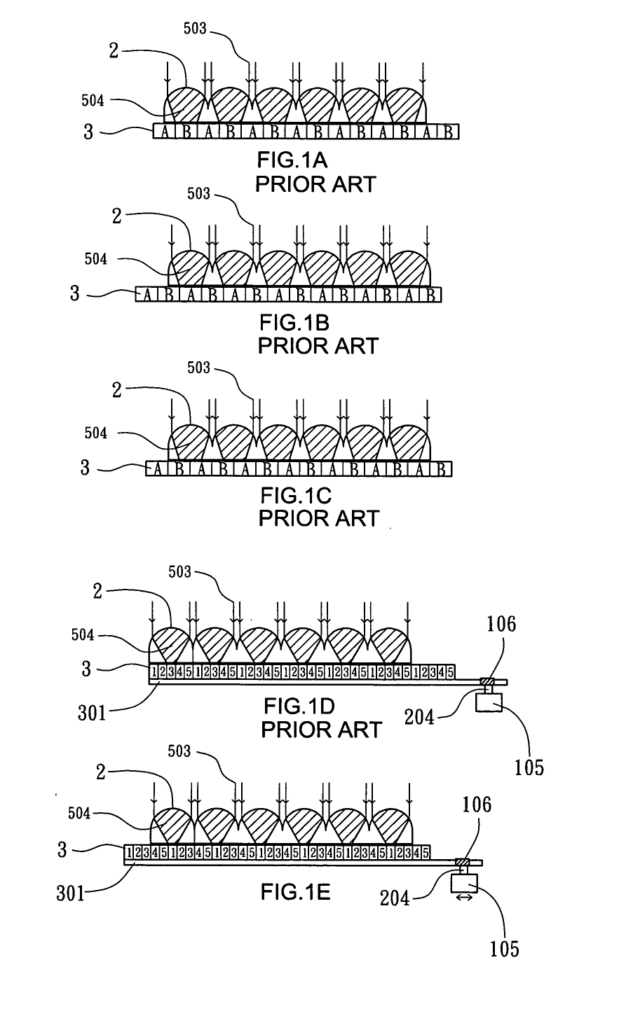

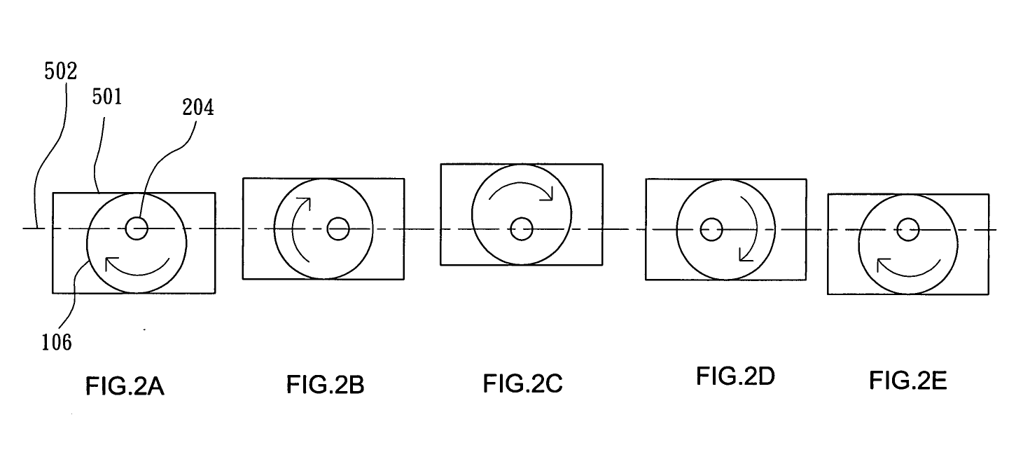

Referring to FIG. 1E, a micro-adjusting motor 105 for the animation continuously displaying frame of the present invention is installed in the mode of movably adjusting position, the micro-adjusting motor 105 can locate the picture of the first action at the initial position, and the pictures on the grating plate 2 are repeatedly presented in the sequence of 1,2,3,4,5 and 5,4,3,2,1.

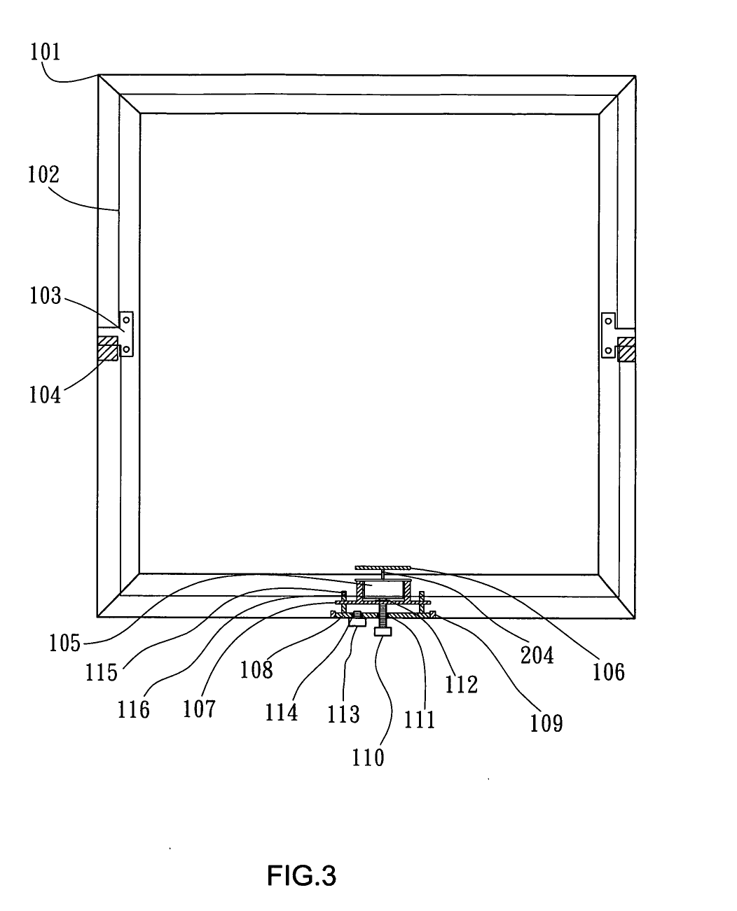

FIGS. 2A to 2E are schematic views showing the actions of moving of the picture sheet driven by a round rotating member 106, the round rotating member 106 eccentrically provided on a rotating axle 204 of the motor is placed in an opening of a moving article 501, the moving article 501 is connected with the grating plate or the picture sheet for changing angle or position.

In FIGS. 2A to 2E, a horizontal line 502 is a line extending through the center of the rotating axle 204 of the motor, the drawings show the moving states of the moving article 501 when the rotating axle 204 is rotated clockwise 90 degrees each time; it can be seen that the moving article 501 being moved always follows the rotating of the rotating axle 204 to move step by step, that makes the grating plate or the picture sheet gradually change its angle for presentation, this gets the object that the pictures in the picture sheet present their dynamic changing. Two embodiments are described below:

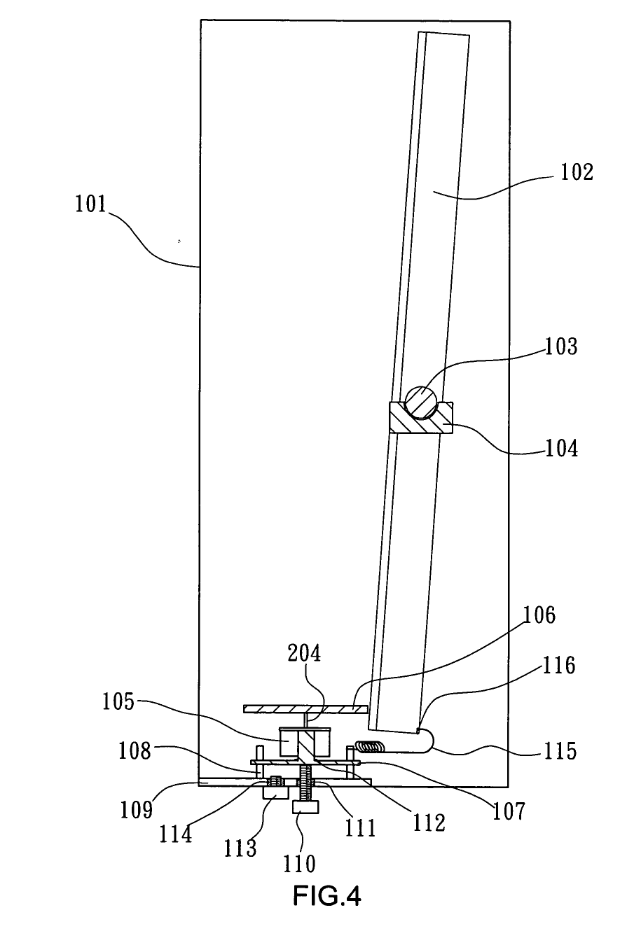

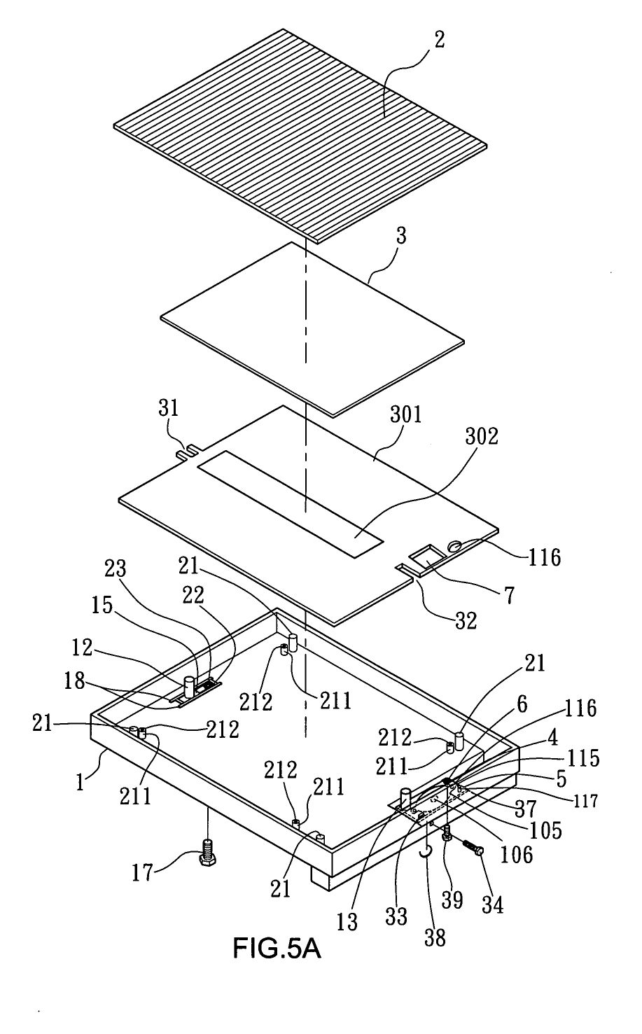

The first embodiment: being applied to an advertisement billboard, referring to FIGS. 3 and 4, the present invention has a framework 101 for an advertisement billboard, the framework 101 has therein semicircle recessed supporting seats 104 each fixed on one of two inner lateral sides of the framework 101 and has a grating plate 102 carrying a picture sheet, at the middle of the grating plate 102, a clamping means with a round axle 103 is provided at each of two sides of the grating plate 102; the two round axles 103 are provided each with a bearing (not shown), the two round axles 103 of the grating plate 102 are placed in the semicircle recessed supporting seats 104 of the framework 101, the grating plate 102 is naturally hung on the supporting seats 104; such a mechanical structure can allow a grating plate of even a larger size to have its angular position changed with a minimum external force, then a spring 115 on a cylindrical column connected with a movable base seat 108 is provided to hook a hole 116 on the bottom of the grating plate 102 in order that the grating plate 102 always clings on the edge of a round rotating member 106. The central hole (not shown) of the round rotating member 106 is mounted on a protruding rotating axle 204 of a motor 105; the motor 105 is fixed on a movable plate 107 having four holes on its periphery; a conductor connecting with the motor is extended through the framework 101 to the outside (not shown); the four holes of the movable plate 107 are slipped over four cylindrical columns on the movable base seat 108 which is fixed thereon with two nuts 111, 114 and is mounted in two protruding rails 109 on the bottom of the framework 101 to limit its direction of movement. A movable screw 110 is extended from outside of the bottom of the framework 101 through a rectangular hole (not shown) of the framework 101 to be locked in the nut 111 of the movable base seat 108, and then is extended through a “C” shaped ring 112 to have the tailing end of the movable screw 110 gripped. If an initial angular position of the grating plate 102 before activating the motor is not a completely presenting angular position for the first picture, the movable screw 110 moves the round rotating member 106 upwards or downwards, and changes the angular position of the grating plate 102 to adjust the initial angular position of the grating plate 102 to be the best angular position to make one of the pictures completely present. Another screw 113 also is extended from outside of the bottom of the framework 101 through the rectangular hole (not shown) of the framework 101 to be locked in the nut 114 of the movable base seat 108; the screw 113 has two functions: Firstly, it can control the base seat 108 to move forwards or rearwards, and in turn control the round rotating member 106 to move forwards or rearwards to adjust the initial angular position of the grating plate 102 to be the best angular position. Secondly, after the aforesaid two ways of adjusting to get the best initial angular position of the grating plate 102, the movable base seat 108 can be fixed on the framework 101 just by locking tight the screw 113.

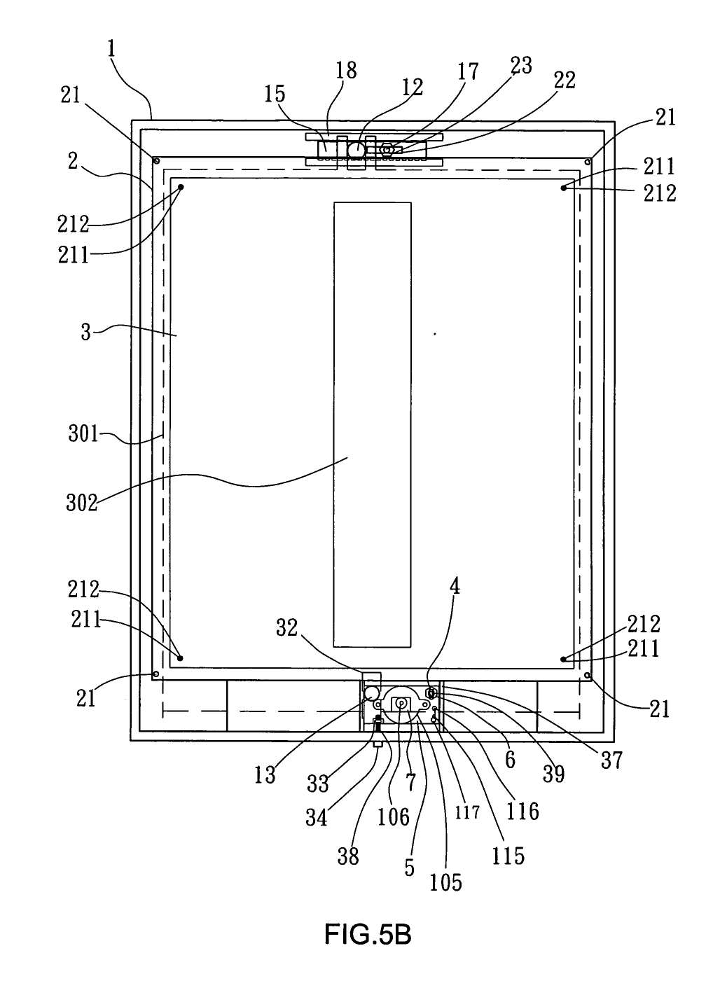

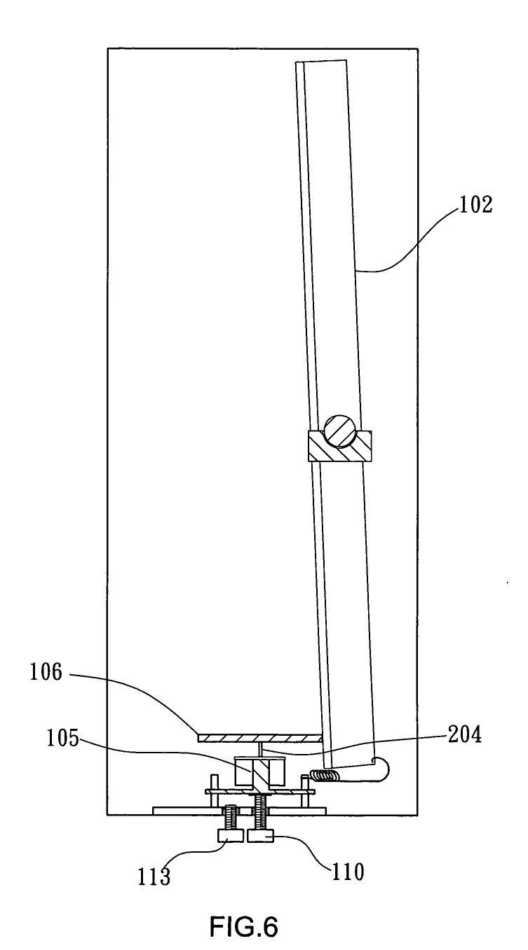

The second embodiment: being applied to a picture frame, the embodiment has three main elements including a framework, a back plate and a tripod, and mainly has improvement on the back plate; referring to FIGS. 5A and 5B; the back plate 1 has therein a recessed space, and has on its upper end a slide plate 15; the slide plate 15 is mounted in two protruding rails 18 on the main body of the back plate 1 to limit its direction of movement, and is provided with a protruding cylindrical column 12; a fixing nut 23 allows a screw 17 to be extended from outside of the bottom of the main body of the back plate 1 through a rectangular hole 22 of the back plate 1 and to be locked in the nut 23. The main body of the back plate 1 totally has four protruding cylindrical columns 21 at four corners of it in order to support a grating plate 2 to keep a suitable distance from a picture sheet 3 below; further there are four shorter protruding cylindrical columns 211 provided near and inwardly of the four protruding cylindrical columns 21, for each of the protruding cylindrical columns 211 a movable screw 212 is locked thereon to support the plain plate 301 for sticking thereon with a picture sheet 3, the picture sheet 3 are stuck with a double sided adhesive tape 302 onto the plain plate 301 sticking with the picture sheet 3; the back plate 1 has on its bottom end a recessed area (not shown) for mounting therein with a movable plate 5 which is mounted in two protruding rails 37 fixed on the main body of the back plate 1 to limit its direction of sliding; the movable plate 5 is fixed thereon with a motor 105, a power line connecting with of the motor 105 is extended through the main body of the back plate 1 to the outside (not shown), the center of a round rotating member 106 is mounted on a protruding rotating axle of the motor 105 (not shown), the movable plate 5 is fixed thereon with an upright nut 33 which is locked therein with a screw 34 extended through a lateral side of the main body of the back plate 1 from outside, a “C” shaped ring 38 grips the screw 34 inside of the lateral side of the back plate 1, the movable plate 5 further is fixed thereon with a laid flat nut 6 which is locked therein with a screw 39 extended through a rectangular hole 4 on the bottom of the main body of the back plate 1 from outside; the movable plate 5 further is provided thereon with a protruding cylindrical column 13 and a protruding cylindrical column 117 which is slipped over a spring 115; when in assembling, the plain plate 301 sticking with the picture sheet is placed over the four shorter protruding cylindrical columns 211, a notch 31 thereon is slipped over the protruding cylindrical column 12, while a lower slit 32 is slipped over the protruding cylindrical column 13, and a lower hole 7 is slipped over the round rotating member 106 on the rotating axle 204 of the motor 105, the plain plate 301 has on its lower side another lower hole 116 which is hooked with the spring 115 to render the plain plate 301 to keep in a state of always clinging on the edge of the round rotating member 106; then the grating plate 2 is placed over the picture sheet 3 to be supported by the four protruding cylindrical columns 21, and to be unmoved by tightly and fixedly clamping by the edges of the main body of the back plate 1; at this time, by micro-adjusting leftwards or rightwards of the screw 17 at an outer position on the bottom of the back plate 1, the angular position of the picture sheet 3 can be changed. When specific veins on the picture sheet 3 are parallel to those of the grating plate 2, the picture sheet 3 gets its correct angular position, now the screw 17 can be tightened, and the screw 34 on the lower outer side of the back plate 1 can move the round rotating member 106 to change the angular position of the picture sheet 3 to render a first one of the pictures to be at a correct initial position to completely presenting the picture on the grating plate 2; and after adjustment, the screw 39 on the bottom outer side of the back plate 1 can be tightened. If the tightness of contact of the picture sheet 3 with the grating plate 2 is not appropriate, the height of the movable screws 212 on the four protruding cylindrical columns 211 can be micro adjusted, the picture sheet 3 and the grating plate 2 can be kept in the best tightness.

The animation continuously displaying frame and the advertisement billboard of the present invention are different from a conventional picture frame for changing of pictures structurally in two aspects: First, the tailing end of a motor of the conventional picture frame for changing of pictures is fixed on a base seat of the picture frame having no design of movability for adjusting. Second, the tightness between the picture sheet/the grating plate and the motor of a conventional picture frame for changing of pictures is fixed and has no design of movability for adjusting.

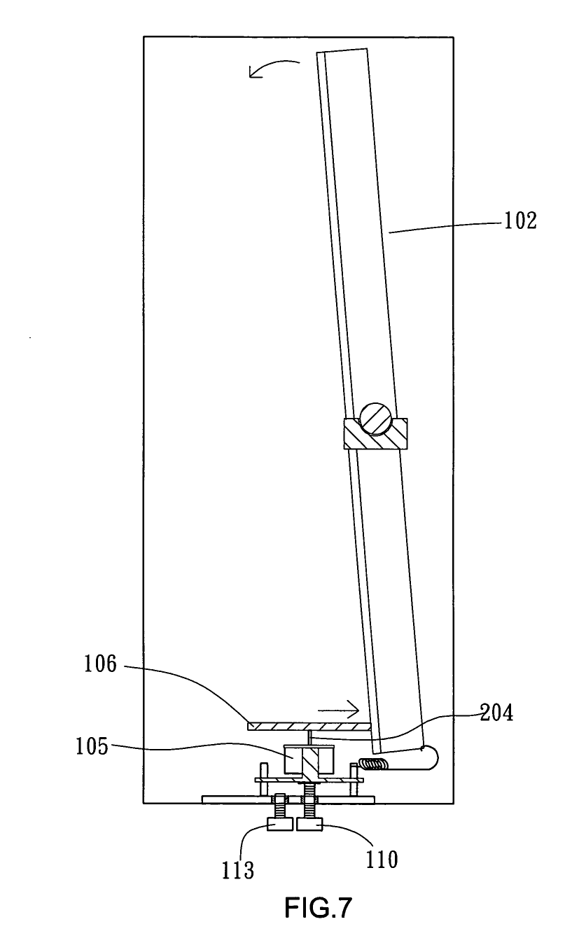

As to the part of designing for adjustment of position moving of the motor 105: the designing is for solving the problem resulted by different refraction angles of different grating plates, referring to FIG. 6, the grating plate 102 placed on the bottom of the framework clings on the edge of the round rotating member 106; if the first picture on the grating plate 102 is not in a position to render it to be completely presented, the movable screw 110 is adjusted to make the motor 105 get higher or lower, and the movable screw 113 is adjusted to move the motor 105 forwards or rearwards; when the motor 105 is adjusted to move higher or forwards, the round rotating member 106 will push the grating plate 102 rightwards to change the angular position of the grating plate 102, such as is shown in FIG. 7, presenting of the pictures on the grating plate 102 will naturally change, it needs only to adjust to make the first picture be in the state of complete presenting.

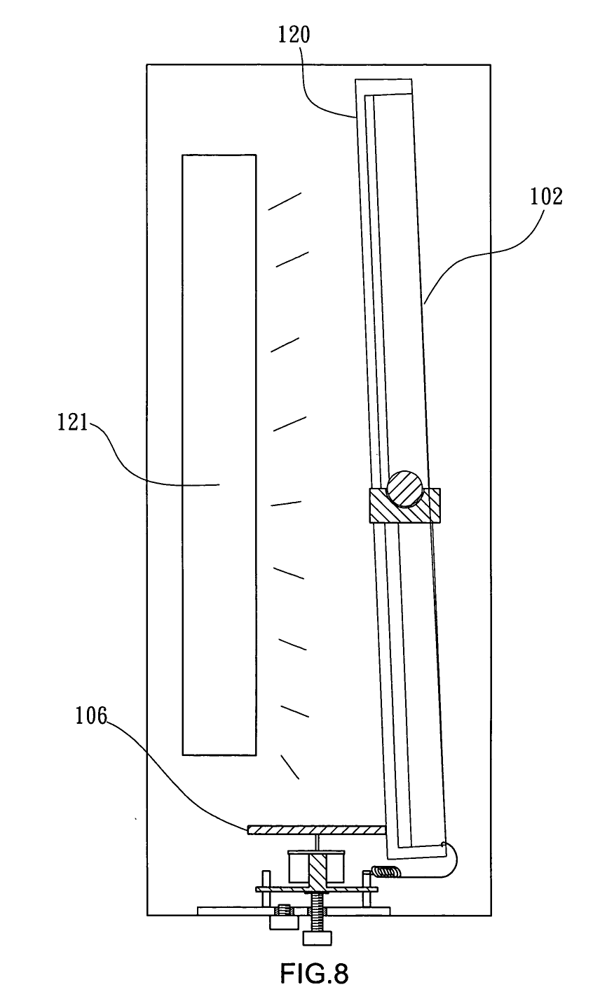

In another embodiment of advertisement billboard shown in FIG. 8 which is a large scale advertisement billboard and is harder to get good evenness in use, wherein four edges and a back side of a grating plate 102 are framed by a framework 120, the two lateral edges of the framework 120 each has at its middle a fixed protruding round axle (not shown) hanging on the frame body; a round rotating member 106 contacts the framework 120 to move the grating plate 102, the front surface of the framework 120 can be mounted with a transparent glass or plastic panel with better evenness to press flat the grating plate 102 to be fixed by the framework 120.

Certainly, light emitting elements can be installed under the picture sheet in a picture frame or an advertisement billboard, such as is depicted in FIG. 8 having a light emitting element 121 which is suitable for use at night or in the dark, these all fall into the scope of the present invention.

The round rotating member 106 mounted on the rotating axle 204 of the motor 105 is an integral type or a combination type.

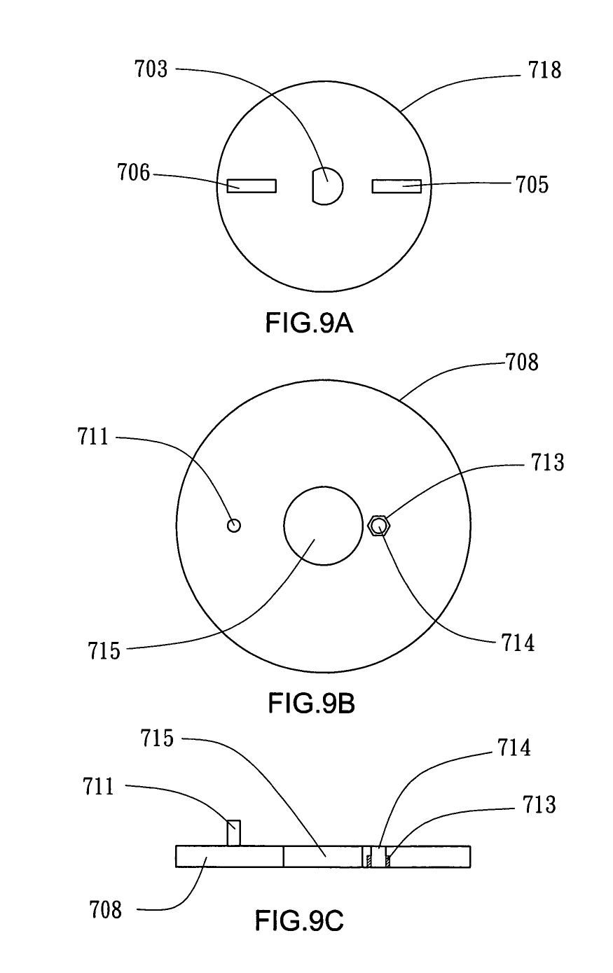

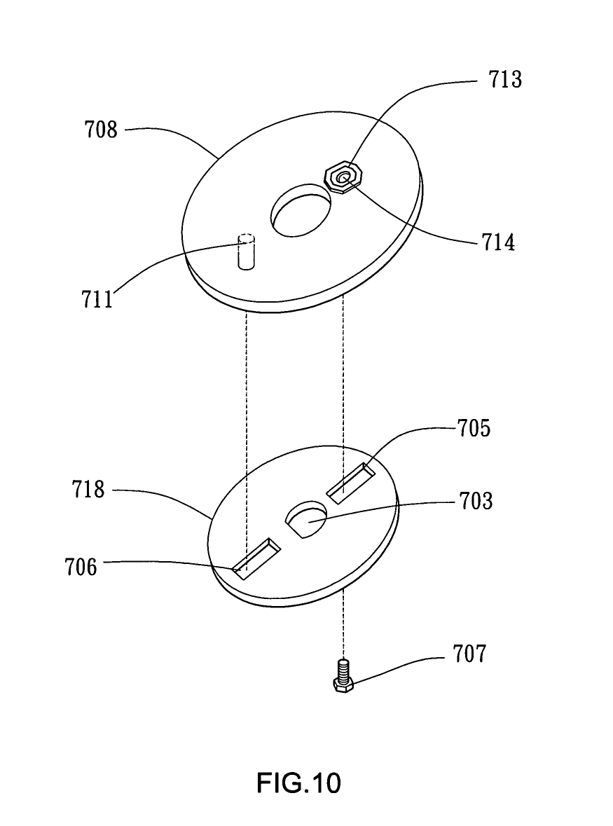

Referring to FIG. 9A, the combination typed round rotating member 106 is composed of a smaller round member 718 and a larger round member 708, the center of the smaller round member 718 has a non-circular hole 703 to match with a protruding rotating axle of the motor, the non-circular hole 703 has at its two lateral sides two rectangular holes 705, 706; and referring to FIGS. 9B and C depicting the larger round member 708, the center of the larger round member 708 has a circular hole 715, at the left side of it there is a protruding cylindrical column 711 and at the right side of it there is a nut 713, the nut 713 has a central circular hole 714. Referring to FIG. 10, when in assembling of the two round members, the smaller round member 718 is beneath the larger round member 708 of which the protruding cylindrical column 711 is slipped in the left rectangular hole 706 on the smaller round member 718. After the nut 713 at the right side of the larger round member 708 is locked therein a movable screw 707 extended through the rectangular hole 705 from the bottom of the smaller round member 718, the combination typed round rotating member 106 can be adjusted to get a suitable eccentric distance of the center of the rotating axle of the motor according to different spaces between veins of various grating plates.

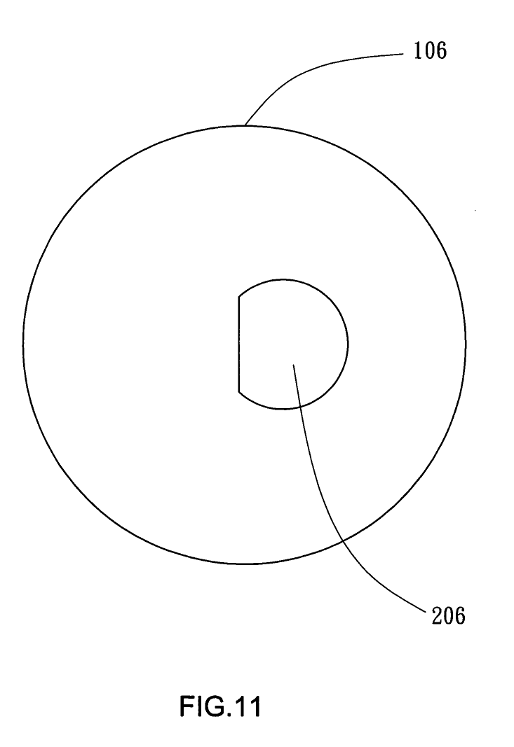

Referring to FIG. 11 showing that a round rotating member of the animation continuously displaying frame of the present invention is a right round member 106, a non-circular hole 206 is provided at the right side of the center of the round member 106 and matches with a protruding rotating axle of a motor.

In conclusion, the innovated structure of the animation continuously displaying frame of the present invention surely can get the function to position the initial position of a first picture to completely presenting all pictures sequentially; it really has improvement, what we claim as new and desire to be secured by Letters Patent of the United States is:

1. An animation continuously displaying frame comprising at least a framework, a picture sheet, a grating plate as well as a combination member composed of a round rotating member with an eccentric hole and a movably mounted motor; said picture sheet includes therein at least two pictures, said picture sheet and said grating plate are assembled in said framework to change positions or angular positions of said picture sheet or said grating plate by means of said round rotating member eccentrically mounted on a rotating axle of said motor and driven by said motor, thereby at least two of said pictures of said picture sheet on said grating plate are presented; said displaying frame is characterized in that: said motor mounted with said round rotating member with an eccentric hole is fixed on a movable plate, said movable plate has a nut fixed thereon and is mounted in two protruding rails on said framework to limit its direction of movement, a movable screw is extended from outside of said framework through a rectangular hole on said framework to be locked in said nut fixed on said movable plate, position or height of said motor is adjusted in order to position any of said pictures on said grating plate or said picture sheet to be at an initial position or angular position.

2. The animation continuously displaying frame as claimed in claim 1, wherein said round rotating member with said eccentric hole is made of plastic or metal.

3. The animation continuously displaying frame as claimed in claim 1, wherein said round rotating member mounted on said rotating axle of said motor is an integral type or a combination type.

4. The animation continuously displaying frame as claimed in claim 1, wherein said displaying frame is a picture frame which has a framework, a back plate and a tripod; said grating plate and said picture sheet are mounted in said framework and are separately mounted in said framework, said picture sheet is placed a predetermined distance under said grating plate after being stuck onto a movable plain plate, said grating plate is fixed on said framework, a notch on an upper end of said plain plate is slipped over a protruding cylindrical column on a slide plate in said back plate, a fixing nut is provided on said slide plate and is locked therein with a screw which is extended through said back plate from outside of said back plate; said screw is tightened after angular position of said picture sheet is well adjusted, said motor is fixed on a movable plate on a lower side in said framework, said rotating axle of said motor is connected with said round rotating member having said eccentric hole, a lower hole on a lower side of said plain plate is slipped over said round rotating member, a lower slit is slipped over a protruding cylindrical column of said movable plate, another lower hole is hooked with a spring on another protruding cylindrical column of said movable plate to render said plain plate to keep in a state of always clinging on an edge of said round rotating member.

5. The animation continuously displaying frame as claimed in claim 4, wherein position of said motor fixed on said movable plate is adjusted with two screws extended through said framework from outside, said motor is adjusted to make an initial position or angular position of said grating plate or said picture sheet be a position for completely presenting said pictures.

6. The animation continuously displaying frame as claimed in claim 4, wherein a main body of said back plate has four protruding cylindrical columns at four corners of it in order to support said grating plate to keep a predetermined distance of it from said picture sheet below; further there are four shorter protruding cylindrical columns provided near and inwardly of said four protruding cylindrical columns, for each of said protruding cylindrical columns a movable screw is locked thereon to support said plain plate for sticking thereon with said pictures, if tightness of contact of said picture sheet with said grating plate is not appropriate, heights of said movable screws on said protruding cylindrical columns are micro adjusted, tightness of said picture sheet and said grating plate thus is adjusted.

7. The animation continuously displaying frame as claimed in claim 1, wherein power equipment is provided for said motor, said power equipment at least includes a power line, a transformer and a switch.

8. The animation continuously displaying frame as claimed in claim 1, wherein light emitting elements and elements including transformers, voltage stabilizers and circuit control boards etc. required by said light emitting elements are installed in said back plate of said picture frame or said framework of said advertisement billboard.

9. The animation continuously displaying frame as claimed in claim 1, wherein two semicircle recessed supporting seats are fixed inside and at the middle of said framework, said grating plate has thereon said picture sheet and is fixedly provided at two sides thereof with two clamping means each having a round axle, said two round axles are placed in said two semicircle recessed supporting seats inside of said framework, said grating plate is naturally hung on said supporting seats, a spring connected to a movable base seat is provided to hook a bottom of said grating plate in order that said grating plate always clings on an edge of said round rotating member; when said round rotating member is rotated by said motor, it changes an angular position of said grating plate.

10. The animation continuously displaying frame as claimed in claim 9, wherein said motor is fixed on a movable plate having four holes on its periphery; said four holes of said movable plate are slipped respectively over four cylindrical columns on said movable base seat which is fixed thereon with two nuts and is mounted in two protruding rails on a bottom of said framework to limit its direction of movement; a movable screw is extended from outside of said bottom of said framework through a rectangular hole of said framework to be locked in one of said nuts of said movable base seat, and then is extended through a “C” shaped ring to have a tailing end of said movable screw gripped; if an initial angular position of said grating plate before activating said motor is not a completely presenting angular position for any of said pictures, said movable screw is rotated to move said round rotating member upwards or downwards, and changes said angular position of said grating plate to adjust said initial angular position of said grating plate to be the best angular position to make one of said pictures completely present.

11. The animation continuously displaying frame as claimed in claim 10, wherein another one of said nuts is locked therein with another screw extended from outside of said bottom of said framework through said rectangular hole of said framework, this controls said base seat to move forwards or rearwards, and in turn controls said round rotating member to move forwards or rearwards to adjust said initial angular position of said grating plate to get the best function of said initial angular position, or this makes said movable base seat be fixed on said framework by locking tight said screw after said grating plate is adjusted to get its best initial angular position.

12. The animation continuously displaying frame as claimed in claim 9, wherein said movable plate and said movable base seat are made of plastic or metal.

13. The animation continuously displaying frame as claimed in claim 9, wherein four edges and a back side of said grating plate are framed by another framework, a front surface of said framework is mounted with a transparent glass or plastic panel to press flat said grating plate to be fixed by said another framework, said round rotating member contacts said another framework to move said grating plate to change angular position of said grating plate.

14. The animation continuously displaying frame as claimed in claim 3, said displaying frame is adapted to automatic picture changing, wherein said round rotating member is a combination type comprising:
a smaller round member, the center of said smaller round member has a hole to match for assembling with a protruding rotating axle of said motor, said hole has at its two lateral sides two rectangular holes; and
a larger round member, the center of said larger round member has a circular hole, at a left side of said circular hole there is a protruding cylindrical column and at a right side of said circular hole there is a nut, said nut has a central circular hole; said protruding cylindrical column at said left side of said circular hole on said larger round member is adapted to inserting into said rectangular hole provided on said smaller round member, a movable screw is extended through another of said rectangular holes from a bottom of said smaller round member into said nut at said right side of said circular hole for fixing said smaller round member, thus a completed one of said round rotating member is formed.

15. The animation continuously displaying frame as claimed in claim 1, said displaying frame is adapted to automatic picture changing, wherein said grating plate is formed by sticking a cylindrical mirror grating plate or a printed grating film onto a transparent plate.
